(19) United States
(12) Patent Application Publication
(10) Pub. No.: US 2011/0216269 A1
(43) Pub. Date: Sep. 8, 2011

(54) LIQUID CRYSTAL DISPLAY DEVICE

(75) Inventors: Kunpei KOBAYASHI, Tachikawa-shi (JP); Norihiro Arai, Hino-shi (JP)

(73) Assignee: CASIO COMPUTER CO., LTD., Tokyo (JP)

(21) Appl. No.: 13/039,337

(22) Filed: Mar. 3, 2011

(30) Foreign Application Priority Data
Mar. 8, 2010 (JP) 2010-050989
Jan. 11, 2011 (JP) 2011-003122

(51) Int. Cl. G02F 1/1335

(52) U.S. Cl. 349/62

(57) ABSTRACT

A liquid crystal display device includes a first substrate, a second substrate, a liquid crystal layer, a light source, a dielectric multilayer film, and a transistor array. The liquid crystal layer is provided between the first substrate and the second substrate. The light source irradiates the liquid crystal layer with light through the first substrate. The dielectric multilayer film is provided on a surface of the first substrate, the surface facing the second substrate. The transistor array is provided on the dielectric multilayer film.

### CROSS-REFERENCE TO RELATED APPLICATIONS

This application is based upon and claims the benefit of priority from prior Japanese Patent Applications No. 2010-050989, filed Mar. 8, 2010; and No. 2011-003122, filed Jan. 11, 2011, the entire contents of both of which are incorporated herein by reference.

### BACKGROUND OF THE INVENTION

1. Field of the Invention

The present invention relates to a liquid crystal display device.

2. Description of the Related Art

The known types of liquid crystal display devices include a transparent liquid crystal display device and a reflective liquid crystal display device.

The transparent liquid crystal display device is configured to perform display using illumination light from the backlight arranged at the back of a liquid crystal panel. The transparent liquid crystal display device provides display with excellent visibility in dark circumstances, such as in a room. In bright circumstances, such as out of doors, however, brightness of the backlight becomes relatively insufficient, and visibility is deteriorated. When light of brightness higher than the surrounding brightness is emitted from the backlight, power consumption will increase.

On the other hand, the reflective liquid crystal display device is configured to perform display by letting the external light that has been made incident from the front of the liquid crystal panel and passed through a liquid crystal layer of a liquid crystal panel once to reflect and be emitted from the front of the liquid crystal panel via the liquid crystal layer again. The reflective liquid crystal display device is capable of providing display with excellent visibility in bright circumstances, such as out of doors. In dark circumstances, such as in a room, however, the brightness will be insufficient.

Under the above-described circumstances, liquid crystal display devices capable of providing both transmissive display and reflective display have recently been developed. For example, Jpn. Pat. Appln. KOKAI Publication No. 2004-93715 discloses dividing each display pixel into two regions, forming a pixel electrode in one of the regions only of a transparent material, and forming a pixel electrode in the other region so as to include a reflective material, such that each display pixel is capable of providing transmissive display and reflective display.

When each display pixel is clearly divided into a transmissive display region and a reflective display region, however, the area of display that can be used for each display will be halved, and the usable light will also be halved. This causes a problem that both of the displays will be dark and the display quality will deteriorate.

### BRIEF SUMMARY OF THE INVENTION

According to an aspect of the invention, a liquid crystal display device includes a first substrate; a second substrate which faces the first substrate; a liquid crystal layer provided between the first substrate and the second substrate; a light source which irradiates the liquid crystal layer with light through the first substrate; a dielectric multilayer film provided on a surface of the first substrate, the surface facing the second substrate; and a transistor array provided on the dielectric multilayer film.

According to another aspect of the invention, a liquid crystal display device includes a first substrate; a second substrate which faces the first substrate; a liquid crystal layer provided between the first substrate and the second substrate; a light source which irradiates the liquid crystal layer with light through the second substrate; a dielectric multilayer film provided on a surface of the second substrate, the surface facing the first substrate; and a color filter array provided on the dielectric multilayer film.

Additional objects and advantages of the invention will be set forth is the description which follows, and in part will be obvious from the description, or may be learned by practice of the invention. The object and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a resolved perspective view illustrating a configuration example of a liquid crystal display device according to a first embodiment of the present invention;

FIG. 2 is a side view illustrating a configuration example of the liquid crystal display device according to the first embodiment of the present invention;

FIG. 3 is an enlarged sectional view illustrating a configuration example of the liquid crystal display panel according to the first embodiment of the present invention;

FIG. 4 is a schematic circuit diagram illustrating a transistor array;

FIG. 5 is an enlarged view illustrating an example of a region P shown in FIG. 3 and a descriptive view of a thin-film transistor;

FIG. 6 illustrates an arrangement example of a color filter;

FIG. 7 is a descriptive view of the trajectory of light from a light-emitting element guided by a light guide plate;

FIG. 8 is a descriptive view of backscatter that occurs in a diffuser panel;

FIG. 9 is an enlarged sectional view illustrating an example of a prism portion;

FIG. 10 is a descriptive view of the trajectory of light reflected off the prism portion;

FIG. 11 is a descriptive view of the direction of each optical axis;

FIG. 12 is a descriptive view of a dielectric multilayer film;

FIG. 13 illustrates a result obtained by measuring the transmittance and reflectance when light is made incident on an aluminum-based thin film;

FIG. 14 illustrates a result obtained by measuring the transmittance and reflectance when light is made incident on a dielectric multilayer film formed of titanium oxide and silicon oxide;

FIG. 15 is a side view illustrating a configuration example of a liquid crystal display panel according to a second embodiment of the present invention; and

FIG. 16 is an enlarged sectional view of the liquid crystal panel according to the second embodiment of the present invention.

### DETAILED DESCRIPTION OF THE INVENTION

Hereinafter, embodiments of the present invention will be described with reference to the accompanying drawings.

### First Embodiment

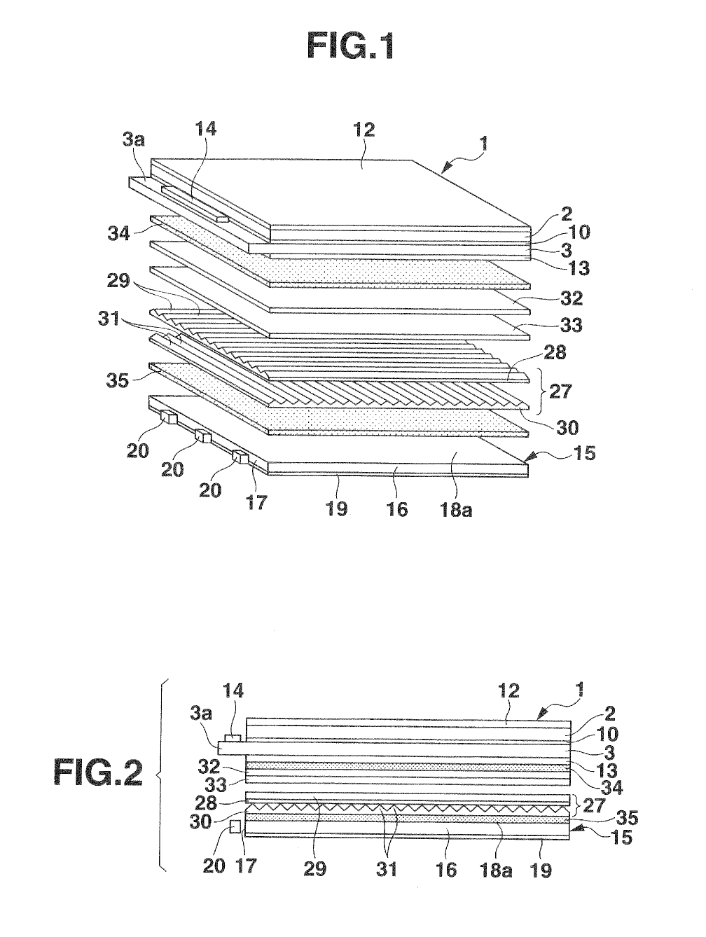

A liquid crystal display device according to a first embodiment of the present invention is configured to provide reflective display using external light, as well as transmissive display using light from a light source. The liquid crystal display device comprises a liquid crystal panel 1, a light source 15 configured to irradiate one surface of the liquid crystal panel 1 with illumination light, a light collecting portion 27 arranged between the light source 15 and the liquid crystal panel 1, a phase difference plate 33 arranged between the light collecting portion 27 and the liquid crystal panel 1, a reflective polarizing plate 32 arranged between the phase difference plate 33 and the liquid crystal panel 1, a first diffuser plate 34 arranged between the reflective polarizing plate 32 and the liquid crystal panel 1, and a second diffuser plate 35 arranged between the light collecting portion 27 and the light source 15, as shown in FIGS. 1 and 2.

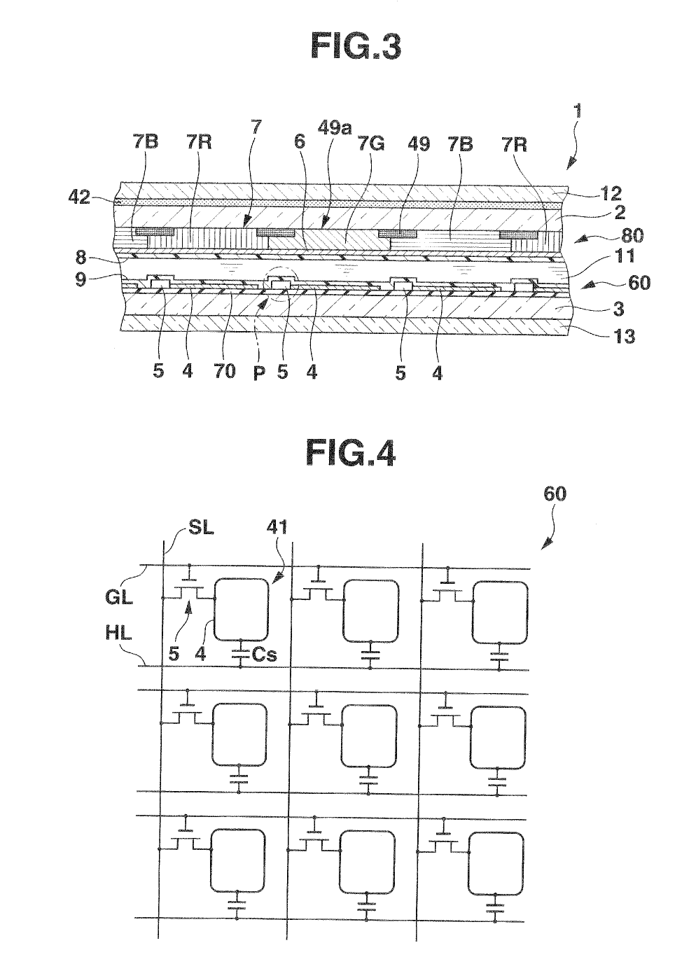

The liquid crystal panel 1 comprises a pair of transparent substrates 2, 3 arranged so as to face each other at a predetermined interval, a liquid crystal layer 11 sealed into a gap between the pair of transparent substrates 2, 3, and a pair of polarizing plates 12, 13 arranged so as to interpose the pair of transparent substrates 2, 3, as shown in FIG. 3. Transmissive axes of the pair of the polarizing plates 12, 13 cross each other at right angles. The pair of transparent substrates 2, 3 are formed of a transparent material, such as a glass substrate. In the description that follows, one of the pair of transparent substrates 2, 3 arranged at the side farther from the light source 15 will be referred to as a second substrate 2, and the other of the pair of transparent substrates 2, 3 arranged on the side closer to the light source 15 will be referred to as a first substrate 3. One of the pair of polarizing plates 12, 13 arranged at the side farther from the light source 15 will be referred to as a second polarizing plates 12, and the other of the pair of polarizing plates 12, 13 arranged on the side closer to the light source 15 will be referred to as a first polarizing plates 13. Between the second transparent substrate 2 and the second polarizing plate 12, a diffusion layer 42 is provided, and the second polarizing plate 12 is attached to the second transparent substrate 2 via a diffusion layer 42.

On the surface facing the second transparent substrate 2 of the first transparent substrate 3, a dielectric multilayer film 70 as a half mirror 70, which will be described below, is evenly formed on the entire surface, as shown in FIG. 3.

On an upper layer of the dielectric multilayer film 70, a transistor array 60 is provided, as shown in FIGS. 3 and 4. The transistor array 60 comprises, a plurality of signal lines SL arranged so as to extend parallel to one another, a plurality of scanning lines GL arranged so as to cross the signal lines SL, a plurality of pixel electrodes 4 formed of a transparent conductive film such as an indium tin oxide, and a plurality of thin-film transistors 5. The pixel electrodes 4 are arranged so as to correspond to cross the signal lines SL and the scanning lines GL. The TFTs 5 arranged so as to correspond to the pixel electrodes 4. That is, a plurality of pixel electrodes 4 are arranged in a matrix such that the pixel electrode 4 is arranged in each of the display pixels 41. Further, each of the scanning lines GL is formed so as to correspond to each pixel row such that a gate signal can be supplied to the TFT5 in each of the pixel row, and each of the signal lines SL is formed so as to correspond to each of the pixel column such that a display signal voltage can be supplied to the pixel electrode 4 is the TFT5. Further, compensatory capacitance lines HL are formed so as to correspond to the pixel rows, and compensatory capacitors Cs are formed in the display pixels 41 via an insulation film arranged between the compensatory capacitance lines HL and the pixel electrodes 4. The compensatory capacitance lines HL are set to a potential equal to that of an opposite electrode 6, which will be described later.

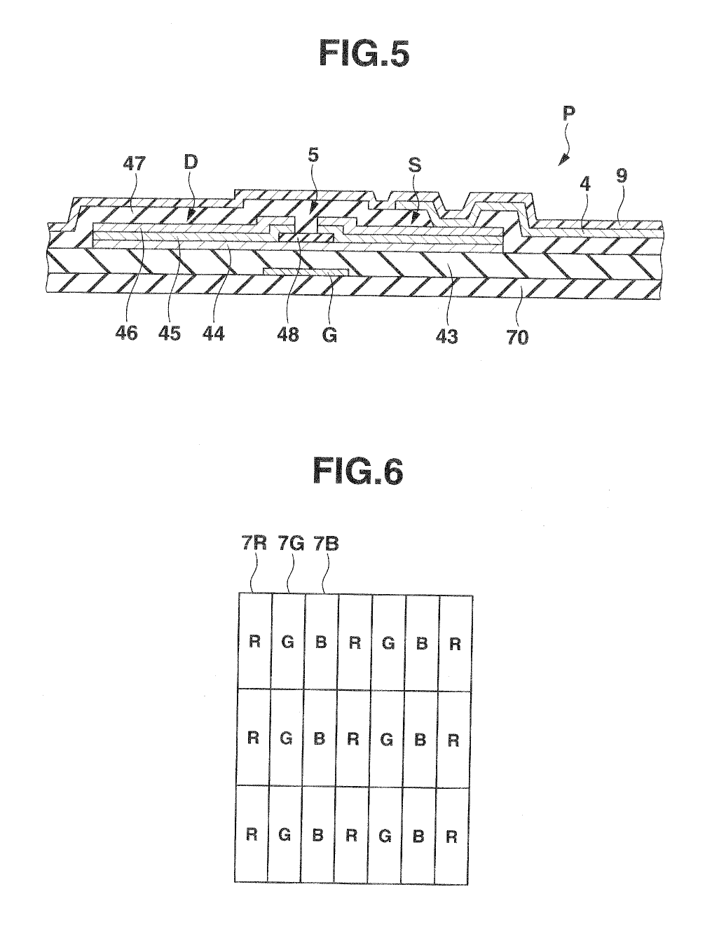

Each of the TFTs 5 includes a gate electrode G formed on the dielectric multilayer film 70, a gate insulation film 43 formed of a transparent insulating material formed so as to cover the gate electrode G, an i-type semiconductor film 44 formed on the gate insulation film 43 so as to face the gate electrode G via the gate insulation film 43, and a drain electrode D and a source electrode S as a metal layer 46 each formed via an n-type semiconductor film 45 on both end portions of the t-type semiconductor film 44, as shown in FIG. 5. In each TFT5, a source electrode S is connected to a corresponding pixel electrode 4 formed on an overcoat film 47, a gate electrode G is connected to a corresponding scanning line GL, and a drain electrode D is connected to a corresponding signal line SL. A channel protection film 48 is formed on the i-type semiconductor film 44 so as to correspond to a channel region.

Each TFT 5 is a thin-film transistor of a bottom-gate type formed of a light-shielding metal, such as aluminum and molybdenum, and is formed such that the gate electrode G contacts the dielectric multilayer film 70. The scanning lines CL and the compensatory capacitance lines HL contact the dielectric multilayer film 70, as the gate electrode G, by being simultaneously formed of the same material with the gate electrode G in the layer in which the gate electrode is formed.

A color filter array 80 is provided on the second substrate 2, as shown in FIG. 3. That is, the light-shielding layer 49 including an aperture 49a at a region approximately corresponding to the pixel electrode 4, the color filter 7, and the opposite electrode 6 are formed in this order from the side of the lower layer on the surface facing the first transparent substrate 3. The light-shielding layer 49 is formed of a light-shielding metal film or resin film. The area of the aperture 49a that lets light to pass through of each of the display pixel 41 is equal to one another. That is, the liquid crystal panel 1 is set such that the aperture ratio is equal in each of the display pixels 41. The color filter 7 is formed of red filters 7R corresponding to red components, green filters 7G corresponding to green components, and blue filters 7B corresponding to blue components. The color filters of corresponding color components are arranged in the respective display pixels, as shown in FIG. 6, for example. The opposite electrode 6 is formed of a transparent conductive film such as an ITO, and is formed so as to be set to an equal potential in each of the display pixels 41. For example, the opposite electrode 6 is formed in the shape of a film so as to cover the color filter 7.

Alignment films 8, 9 are provided on each of the pixel electrode 4 and the opposite electrode 6, so as to control the initial orientation state of liquid crystal molecules in the liquid crystal layer 11. The alignment films 8, 9 are subjected to alignment treatment such that the liquid crystal molecules of the liquid crystal layer 11 are twistedly aligned at the twist angle of 90 degrees when a voltage is not applied to between the pixel electrode 4 and the opposite electrode 6, for example.

A pair of transparent substrates 2, 3 are jointed with a frame-shaped sealing member 10 arranged so as to surround the image display area in which a plurality of pixel electrodes 4 are arranged, as described above, and liquid crystal molecules are sealed into the region surrounded by the frame-shaped sealing member 10.

In the liquid crystal panel 1, the first transparent substrate 3 is arranged facing the second substrate 2 so as to protrude from one side of the second transparent substrate 2, and a driver circuit 14 is mounted on the protruding portion 3a. The driver circuit 14 is electrically connected to a plurality of terminals formed in the protruding portion 3a, supplies a scanning signal to each of the scanning lines GL and supplies each of the signal lines SL with a display signal voltage, and supplies each of the compensatory capacitance lines HL and the opposite electrode 6 with a common voltage via the terminals.

By controlling the voltage applied to the liquid crystal layer 11 via the pixel electrode 4 and the opposite electrode 6, the driver circuit 14 varies the inclination angle or the direction angle of liquid crystal molecules with respect to the transmissive axis of the pair of polarizing plates 12, 13. In this way, the driver circuit 14 controls the amount of light that has passed through the liquid crystal panel 1 in each of the display pixels 4.

The light source 15 is a side-light-type backlight, as shown in FIGS. 1 and 2. The light source 15 includes a light guide plate 16 formed of a plate-shaped transparent member having an area greater than that of the image display area in the liquid crystal panel 1, a reflective plate 19 arranged so as to face the light guide plate 16, and a plurality of light-emitting elements 20 configured to irradiate one of the end surfaces of the light guide plate 16 with light.

A plurality of light-emitting elements 20 are configured to emit light when the liquid crystal display device performs transmissive display using irradiation light from the light source 15, and each of the light-emitting elements 20 includes a red LED, a green LED, and a blue LED. The light-emitting elements 20 are preferably configured such that the light is controllable between on and off according to the brightness of the environment in which the liquid crystal display device is used.

The light guide plate 16 is configured to guide light of each color component with which an end surface 17 of the light guide plate 16 is irradiated from the light-emitting element 20, and irradiate the liquid crystal panel 1 with the light from one main surface 18a facing the liquid crystal panel 1. On the other main surface 18b opposite to the first main surface 18a, for example, a plurality of linear grooves GB are formed so as to extend parallel to the end surface 17 irradiated with light by the light-emitting element 20. The cross-sectional shape of the groove GB is formed such that two sides GB1, GB2 interposing the vertex, for example, become different angles of inclination with respect to the first main surface 18a of the light guide plate 16. More specifically, the angle of inclination of one side GB1 positioned on the side on which the light-emitting element 20 is arranged is formed so as to be greater than that of the other side GB2.

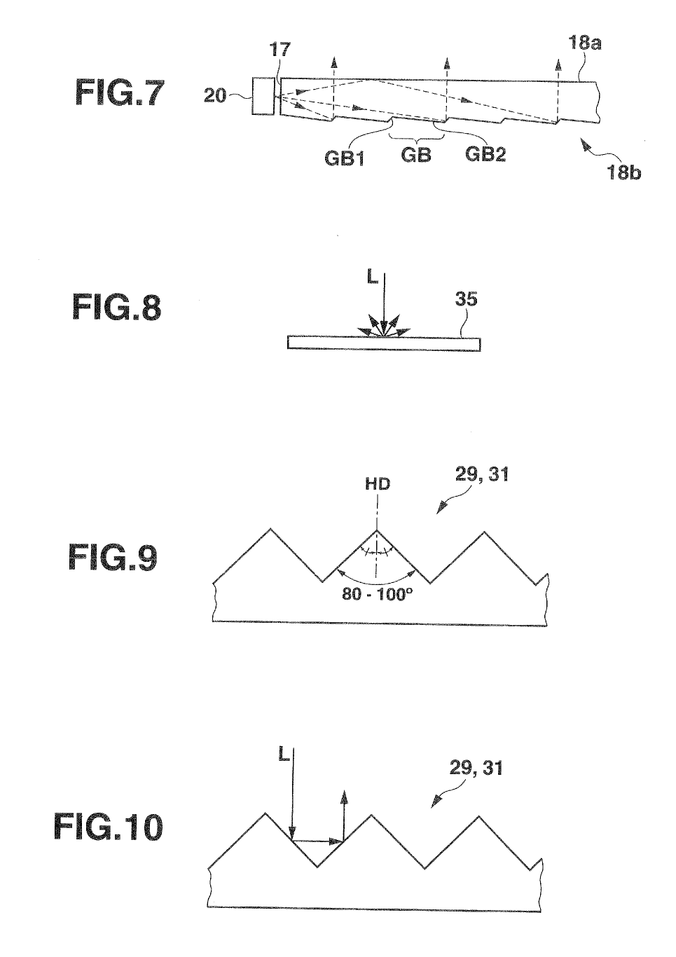

The light guide plate 16 internally reflects the light made incident from the end surface 17 and emits the light toward the liquid crystal panel 1 from the first main surface 18a of the light guide plate 16, as shown in dashed arrows in FIG. 7. The light guide plate 16 may be formed of a transparent material having a refractive index of 1.5, for example, such as acryl.

The reflective plate 19 reflects light from the light-emitting element 20 that has leaked from the second main surface 18b of the light guide plate 16 toward the light guide plate 16, and reflects the external light L that has passed through the liquid crystal panel 1 and the light guide plate 16 toward the light guide plate 16 and the liquid crystal panel 1 again. That is, while the reflective plate 19 improves the usability of the light when the liquid crystal display device performs transmissive display using light emitted from the light-emitting element 20, the reflective plate 19 also functions as a reflective plate designed to reflect the external light L when the liquid crystal display device performs reflective display using the external light L. The reflective plate 19 may be formed by evaporating metal such as silver or aluminum on a glass substrate or a plastic substrate, for example.

The second diffuser plate 35 is designed to reduce in-plane variation of light emitted from the light guide plate 16 by diffusing the light emitted from the first main surface 18a of the light guide plate 16. The second diffuser plate 35 is formed of a transparent sheet in which light-scattering particles are dispersed such that the haze value becomes 55-85%. Since the second diffuser plate 35 backscatters a portion of the external light L that has passed through the liquid crystal panel 1, as shown in FIG. 8, the second diffuser plate 35 also functions as an auxiliary reflective plate when the liquid crystal display device performs reflective display using the external light L.

The light collecting portion 27 is designed to collect light such that the light emitted toward the liquid crystal panel 1 from the light guide plate 16 and diffused by the second diffuser plate 35 travel to the liquid crystal panel 1 more efficiently. The light collecting portion 27 is formed of a first prism array 28 and a second prism array 30 formed of a transparent sheet-like member of acrylic resin, for example. The first prism array 28 is formed such that a plurality of linear prism portions 29 are arranged parallel to one another on one surface. Further, the first prism array 28 is arranged such that the prism portions 29 extend in the direction that crosses the direction in which a plurality of grooves GB formed in the light guide plate 16, for example, extend. The second prism array 30 is formed such that a plurality of linear prism portions 31 are arranged parallel to one another on one surface. The second prism array 30 is arranged such that the prism portions 31 extend parallel to the grooves GB formed in the light, guide plate 16, for example, extended. Each of the prism portions 29, 31 is a bilaterally symmetric isosceles triangle with respect to a normal HD of the liquid crystal panel 1, and has a cross-sectional shape in which the top angle is set within the range of 80 to 100 degrees or preferably set to 90 degrees.

As shown in FIG. 10, since the prism arrays 28, 30 reflect a portion of the external light L that has passed through the liquid crystal panel 1 off the inclination surface forming each of the prism portions 29, 31, the prism arrays 28, 30 also function as an auxiliary reflective plate when the liquid crystal display device performs reflective display using the external light.

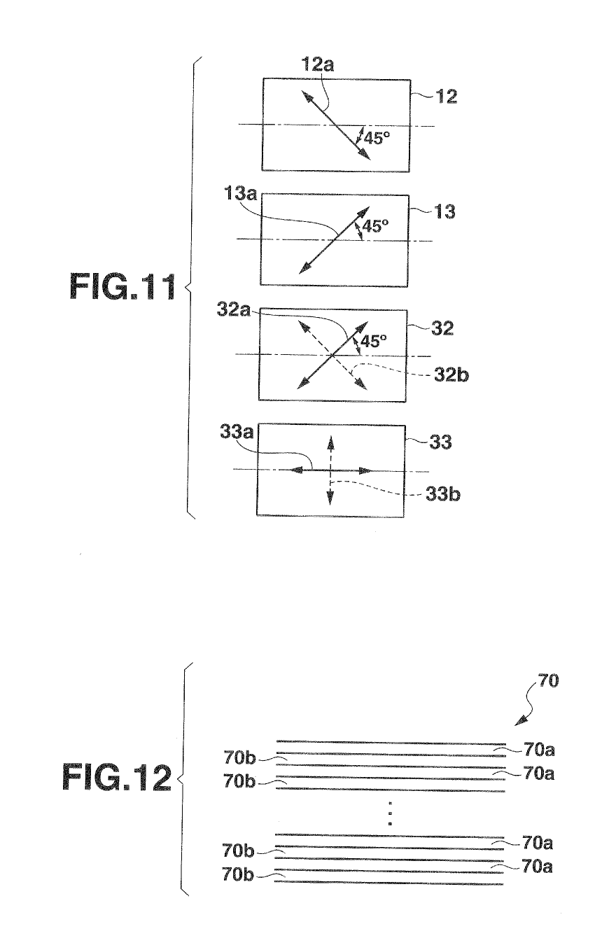

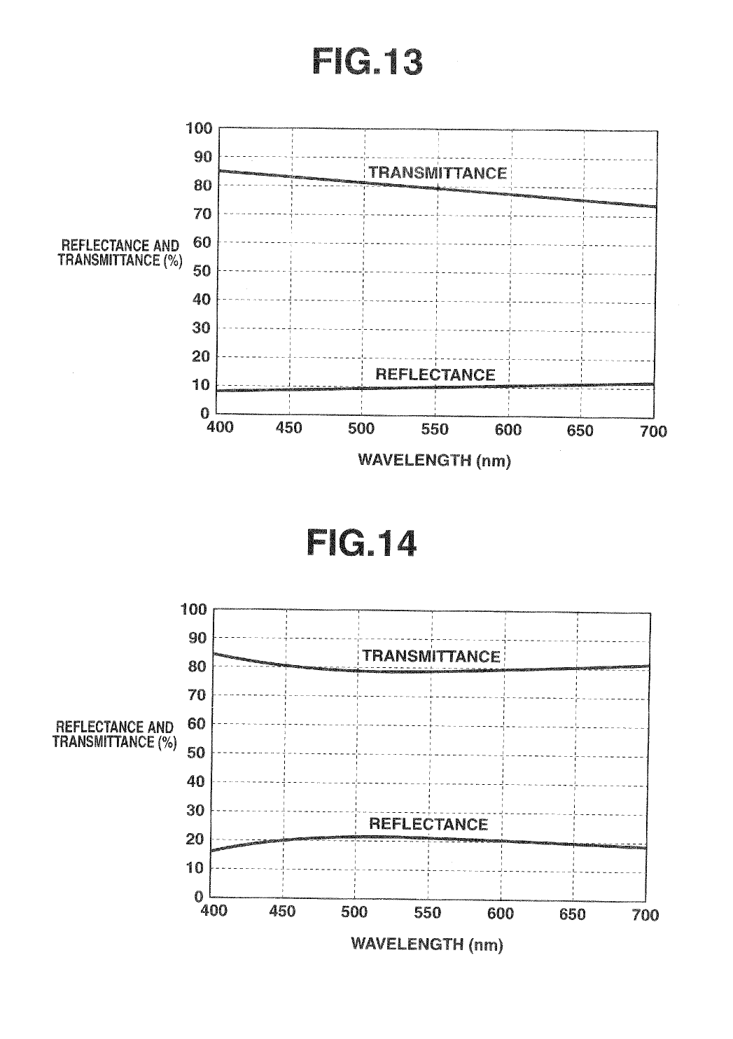

As shown in FIG. 11, the reflective polarizing plate 32 has a transmissive axis 32a and a reflective axis 32b in directions that cross each other at right angles, and is configured to let light of the incident light that has a polarization component parallel to the transmissive axis 32a pass through, and reflect light having a polarization component parallel to the reflective axis 32b. The reflective polarizing plate 32 is arranged such that a transmissive axis 32a of the reflective polarizing plate 32 becomes parallel to a transmissive axis 13a of the first polarizing plate 13. Although the transmissive axis 12a of the second polarizing plate 12 is arranged so as to cross the transmissive axis 13a of the polarizing plate 13 at right angles, as described above, the arrangement can be set as appropriate according to the orientation mode of the liquid crystals in the liquid crystal layer 11.

The phase difference plate 33 includes a slow axis 33a and a fast axis 33b, and is arranged such that the slow axis 33a and the fast axis 33b form an angle of 45 degrees with respect to the transmissive axis 32a and the reflective axis 32b of the reflective polarizing plate 32. The phase difference plate 33 is set to have an optical constant such that a phase difference of ¼ wavelength is applied between light having a polarization component parallel to the slow axis 33a and light having a polarization component parallel to the fast axis 33b.

As described above, by arranging the reflective polarizing plate 32, the phase difference plate 33, and the reflective plate, light which is emitted from the light-emitting element 20 via the light guide plate 16 to the liquid crystal panel 1 and which has a polarization direction crossing the transmissive axis 13a of the polarizing plate 13 is reflected off the reflective polarizing plate 32, converted into light which has a polarization direction parallel to the transmissive axis 3a of the polarizing plate 13, and the liquid crystal panel 1 is irradiated with the light again. Thereby, usability of light from the light-emitting element is improved.

The first diffusion plate 34 is designed to prevent occurrence of moiré between the prism arrays 28, 30 in the display pixel of the liquid crystal panel 1 and the light-collecting portion 27. The first diffusion plate 34 is formed of a transparent sheet in which light-scattering particles are dispersed such that the haze value becomes 20-50%. As in the case of the second diffuser plate 35, since the first diffuser plate 34 backscatters a portion of the external light that has passed through the liquid crystal panel 1, the first diffuser panel 34 also functions as an auxiliary reflective plate when the liquid crystal display device performs reflective display using the external light.

The dielectric multilayer film 70 as a half mirror 70 will be described. As shown in FIG. 12, the dielectric multilayer film 70 is formed of combination of a dielectric material 70a having relatively low refractive index and a dielectric material 70b having a relatively high refractive index, such that they are alternately stacked on one another in a multilayer. For example, the refractive index of the dielectric material 70a having a low refractive index is approximately 1.3 to 1.5, and the refractive index of the dielectric material 70b having a high refractive index is approximately 1.9 to 2.5. As the dielectric material 70a having a low refractive index, silicon oxide or magnesium fluoride may be used. As the dielectric material 70b having a high refractive index, titanium oxide, zinc sulfide, zirconium oxide, niobium oxide, tantalum oxide, cerium oxide, hafnium oxide, neodymium oxide, tungsten oxide, tin oxide, tin-doped indium oxide, yttrium oxide, or the like may be used.

When silicon oxide is used as the dielectric material 70a having a low refractive index and titanium oxide is used as the dielectric material 70b having a high refractive index, the film thickness of each of the silicon oxide layer and the titanium oxide layer is preferably approximately 50 nm. In this case, the reflectance can be set according to the number of layers of the silicon oxide layers and the titanium oxide layers. For example, by alternately stacking approximately 2-6 layers of silicon oxide layers and titanium oxide layers, reflectance of approximately 20% can be obtained with respect to visible light. Further, by alternately stacking approximately 6-10 layers of silicon oxide layers and titanium oxide layers, reflectance of approximately 40% can be obtained with respect to visible light.

The dielectric multilayer film 70 is configured to provide bright reflective display by reflecting a portion of the external light L made incident on the liquid crystal layer 11 after the external light L has passed through the liquid crystal layer 11. The reflectance of the dielectric multilayer film 70 is set as appropriate according to the device to which the liquid crystal display device is applied. That is, the external light L that has passed through the liquid crystal panel 1 travels between the liquid crystal panel 1 and an optical member arranged at the back of the liquid crystal panel 1 and is made incident on the liquid crystal panel 1 again. Due to the traveling between the liquid crystal panel 1 and the optical member, brightness deterioration occurs. The dielectric multilayer film 70 suppresses such deterioration in brightness by reflecting a portion of the external light L in advance.

Although the illumination light from the light source 15 is also reflected off the dielectric multilayer film 70, the reflective light is reflected off the reflective plate 19 and therefore can be reused, as in the case of the external light L that has passed through the dielectric multilayer film 70.

It is to be noted that the silicon oxide and the titanium oxide can be formed by a sputtering device, for example. Since silicon oxide and titanium oxide has sufficient adhesiveness to glass, they can be formed directly on the first transparent substrate 3 formed of a transparent material such as glass. Silicon oxide has a greater affinity than titanium oxide for a light-shielding material that forms a gate electrode, such as chromium, aluminum, molybdenum, and the like. That is, since the titanium oxide has a greater film stress than silicon oxide when formed as a thin film, the gate electrode G will more likely to become detached when the gate electrode G is formed on a titanium oxide layer than when the gate electrode G is formed on the silicon oxide layer. Accordingly, the dielectric multilayer film 70 is preferably formed by alternately stacking silicon oxide layers and titanium oxide layers such that the top layer is the silicon oxide layer. The thin-film transistor 5 should preferably be formed such that the layer as the gate electrode G contacts the silicon oxide layer.

The half mirror 70 is not limited to the dielectric multilayer film 70, and may be formed of an aluminum-based metal thin film. In this case, however, since the sum of the light reflectance and transmittance of each waveform in the visible light range is approximately 90%, there will be loss of light of approximately 10%. Further, since the longer wavelengths will have a lower transmittance than the shorter wavelengths, transmitted light will be tinged with blue.

When the above-described dielectric multilayer film 70 is described as the half mirror 70, the sum of the light reflectance and transmittance in each waveform in the visible light range will be approximately 100%, as shown in FIG. 14. This is preferable since the loss of light can be suppressed. This is further preferable since the coloring of the transmittance light and coloring of the reflective light can be suppressed.

In the above-described liquid crystal display device, when the application voltage is controlled such that the liquid crystal layer 11 in the liquid crystal panel 1 is capable of letting light pass through, the external light passes through the liquid crystal panel 1, and can be made incident on the light guide plate 16, regardless of whether the light-emitting element 20 emits light. The external light made incident on the light guide plate 16 passes through the first main surface 18a and the second main surface 18b of the light guide plate 16 in this order and are reflected off the reflective plate 19, and then pass through the second main surface 18b and the first main surface 18a of the light guide plate 16 in this order, and then travel back to the liquid crystal panel 1. That is, in the above-described liquid crystal display device, display using external light, that is, reflective display can be performed, as well as transmissive display using light emitted by the light-emitting elements 20, without the need to divide a display pixel into a transmissive display region and a reflective display region.

Further, in the above-described liquid crystal display device, a portion of the external light is auxiliarily reflected by the half mirror 70, the first diffuser plate 34, the second diffuser plate 35, the prism arrays 28, 30, and the like, in addition to the reflection of the external light off the reflective plate 19 of the light source 15. Accordingly, since a plurality of reflective surfaces will exist between the liquid crystal panel 1 and the reflective plate 19, a blur can be caused by the external light in the image of the liquid crystal panel 1 projected on the reflective plate 19. Therefore, even if there is a distance of a certain degree between the liquid crystal panel 1 and the reflective plate 19, the image displayed on the liquid crystal panel 1 will be prevented from being recognized as being doubled, and thereby the display quality can be improved.

Since the external light that has reflected off the half mirror 70 is reflected before it passes through the first polarizing plate 13, there will be double the phase difference of the other light. Accordingly, when the reflectance of the half mirror 70 is set high, the driver circuit 14 should preferably be configured such that the voltage applied to the liquid crystal layer 11 is switchable between the transmissive display mode in which the light source 15 is turned on and the reflective display mode in which the light source 15 is turned off. For example, the driver circuit 14 should preferably be configured such that the application voltage to the liquid crystal layer 11 that is assigned to each or the gradation levels is set lower in the reflective display mode than in the transmissive display mode.

Since the half mirror 70 uses reflective light efficiently, the half mirror 70 may be formed on the first transparent substrate 3 roughed by frost processing, for example, so as to be diffusely reflected. Further, although the first transparent substrate 3 may be flat, the half mirror 70 is formed by roughing so as to be diffusely reflected.

In the description given above, the case of the TN mode has been described where the liquid crystal molecules in the liquid crystal layer 11 are twistedly aligned at the twist angle of 90 degrees, but the orientation mode is not limited to the TN mode and may be vertical alignment mode, in which the initial orientation state of the liquid crystal molecules are controlled to vertical alignment, or optically compensated birefringence mode, in which the initial orientation state of the liquid crystal molecules are controlled to bend alignment. Furthermore, in-plane switching mode, which is a in-plane type, may also be applied.

### Second Embodiment

liquid crystal display device according to the second embodiment of the present invention will be described. In the second embodiment, description will be given with reference to only difference from the first embodiment, and the same elements will be denoted by the same reference numbers and detailed descriptions of such elements will be omitted. In the liquid crystal display device according to the first embodiment, the half mirror 70 is provided on the first transparent substrate 3, and a case has been described where the transistor array 60 is provided on the half mirror 70. That is, a case has been described where the first transparent substrate 3 is arranged on the side of the light source 15 in which the transistor array 60 is formed.

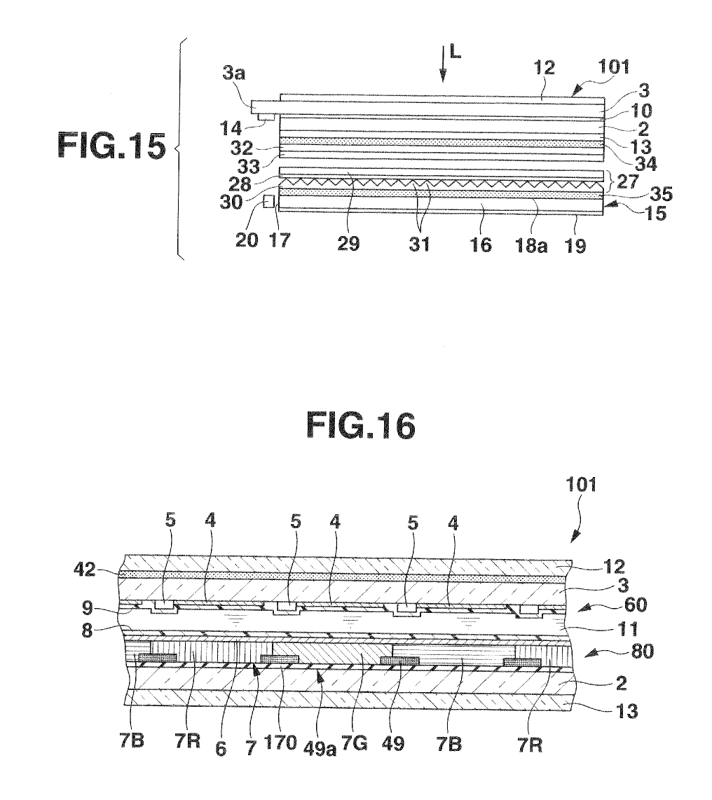

On the other hand, in the liquid crystal display device according to the second embodiment, as shown in FIGS. 15 and 16, a second substrate 2, in which a color filter 7 is provided in a display panel 101, is arranged on the side of a light source 15, and a half mirror 170 is provided on the second substrate 2.

On the second transparent substrate 2, as shown in FIGS. 15 and 16, a dielectric multilayer film 170 as a half mirror 170 is formed evenly on the entire surface facing the first transparent substrate 3. A color filter array 80 is provided on the upper-layer side of the dielectric multilayer film 170. More specifically, a light-shielding layer 49 including an aperture 49a at the region approximately corresponding to the pixel electrode 4, a color filter 7, and an opposite electrode 6 are formed in this order from the lower-layer side on the surface facing the first transparent substrate 3. In this case, the light-shielding layer 49 is formed so as to contact the dielectric multilayer 170. Accordingly, when the light-shielding layer 49 is formed of a light-shielding metal, such as chromium or molybdenum, the dielectric multilayer 170 is preferably formed such that the top layer is formed as a silicon oxide layer, as described above.

On the first transparent substrate 3, on the other hand, a half mirror is not formed, and a transistor array 60 is provided.

According to the liquid crystal display device of the second embodiment, it is possible to provide display using external light, i.e., reflective display, as well as transmissive display using light emitted by each of the light-emitting elements 20, without dividing each display pixel into a transmissive display region and a reflective display region.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
a first substrate;
a second substrate which faces the first substrate;
a liquid crystal layer provided between the first substrate and the second substrate;
a light source which irradiates the liquid crystal layer with light through the first substrate;
a dielectric multilayer film provided on a surface of the first substrate, the surface facing the second substrate; and
a transistor array provided on the dielectric multilayer film.

2. The liquid crystal display device according to claim 1, wherein
the dielectric multilayer film includes one or more first layers comprising silicon oxide and one or more second layers comprising titanium oxide, and
the first layers and the second layers are alternately stacked on one another.

3. The liquid crystal display device according to claim 2, wherein
the transistor array includes a bottom-gate type thin-film transistor,
the thin-film transistor includes a gate electrode, and
the gate electrode contacts the dielectric multilayer film.

4. The liquid crystal display device according to claim 3, wherein the gate electrode contacts an uppermost layer of the first layers.

5. The liquid crystal display device according to claim 4, wherein the gate electrode is formed of light-shielding material comprising at least one of chromium, aluminum, and molybdenum.

6. The liquid crystal display device according to claim 1, wherein
the dielectric multilayer film includes one or more first layers comprising a first dielectric material having a refractive index of greater than or equal to 1.3 and less than or equal to 1.5, and one or more second layers comprising a second dielectric material having a refractive index of greater than or equal to 1.9 and less than or equal to 2.5, and
the first layers and the second layers are alternately stacked on one another.

7. The liquid crystal display device according to claim 6, wherein
the transistor array includes a bottom-gate type thin-film transistor,
the thin-film transistor includes a gate electrode, and
the gate electrode contacts the dielectric multilayer film.

8. The liquid crystal display device according to claim 7, wherein the gate electrode contacts an uppermost layer of the first layers.

9. The liquid crystal display device according to claim 8, wherein the gate electrode comprises a light-shielding material comprising at least one of chromium, aluminum, and molybdenum.

10. The liquid crystal display device according to claim 1, wherein the light source is a side-light-type backlight, and
the light source includes:
a reflective plate; and
a light guide plate arranged between the first substrate and the reflective plate.

11. A liquid crystal display device comprising:
a first substrate;
a second substrate which faces the first substrate;
a liquid crystal layer provided between the first substrate and the second substrate;
a light source which irradiates the liquid crystal layer with light through the second substrate;
a dielectric multilayer film provided on a surface of the second substrate, the surface facing the first substrate; and
a color filter array provided on the dielectric multilayer film.

12. The liquid crystal display device according to claim 11, wherein
the dielectric multilayer film includes one or more first layers comprising silicon oxide and one or more second layers comprising titanium oxide, and
the first layers and the second layers are alternately stacked on one another.

13. The liquid crystal display device according to claim 12, wherein
the color filter array includes a light-shielding layer,
the light-shielding layer contacts the dielectric multilayer film.

14. The liquid crystal display device according to claim 13, wherein the light-shielding layer contacts an uppermost layer of the first layers.

15. The liquid crystal display device according to claim 14, wherein the light-shielding layer is formed of a light-shielding material comprising at least one of chromium and molybdenum.

16. The liquid crystal display device according to claim 11, wherein
the dielectric multilayer film includes one or more first layers comprising a first dielectric material having a refractive index of greater than or equal to 1.3 and less than or equal to 1.5, and one or more second layers comprising a second dielectric material having a refractive index of greater than or equal to 1.9 and less than or equal to 2.5, and
the first layers and the second layers are alternately stacked on one another.

17. The liquid crystal display device according to claim 16, wherein
the color filter array includes a light-shielding layer,
the light-shielding layer contacts the dielectric multilayer film.

18. The liquid crystal display device according to claim 17, wherein the light-shielding layer contacts an uppermost layer of the first layers.

19. The liquid crystal display device according to claim 18, wherein the light-shielding layer comprises a light-shielding material comprising at least one of chromium and molybdenum.

20. The liquid crystal display device according to claim 11, wherein the light source is a side-light-type backlight, and
the light source includes:
a reflective plate; and
a light guide plate arranged between the second substrate and the reflective plate.
